(19) United States
(12) Patent Application Publication
(10) Pub. No.: US 2008/0187244 A1
(43) Pub. Date: Aug. 7, 2008

(54) IMAGE PROCESSING APPARATUS AND IMAGE PROCESSING METHOD

(75) Inventor: Hirokazu Shoda, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/670,708

(22) Filed: Feb. 2, 2007

(51) Int. Cl. G06K 9/32

(52) U.S. Cl. 382/294

(57) ABSTRACT

With respect to images read by an image reading apparatus, determination of a color original document or a monochrome original document is made for every document, and a processing suitable for each is used, so that images with good visibility are obtained. In order to achieve this object, according to the invention, there are included a color original document monochrome processing unit 74 to perform a monochrome image formation processing on a color original document, a monochrome original document processing unit 73 to perform a monochrome image formation processing different from the monochrome image formation processing of the color original document monochrome processing unit 74 on a monochrome original document, and a selection unit (CPU 75) to selectively use the color original document monochrome processing unit 74 and the monochrome original document processing unit 73 for each original document.

### BACKGROUND OF THE INVENTION

1. Field of the Invention

The present invention relates to an image processing apparatus and an image processing method used for a scanner or a digital copier in which image information is read by scanning an original document by a CCD line sensor.

2. Description of the Related Art

Hitherto, as CCD line sensors used for a reducing optical system, there are generally used a line sensor structured by a one-line line sensor, and a sensor structured by a three-line line sensor in which color filters of red (hereinafter also denoted as R), green (hereinafter also denoted as G) and blue (hereinafter also denoted as B) are respectively disposed on surfaces of three line sensors.

The one-line CCD line sensor is basically used for monochrome original document reading. When a color original document is read by using the one-line CCD line sensor, there is adopted a system in which three light sources having spectral characteristics of R, G and B as the three primary colors of light are provided, these light sources are sequentially turned on, and image information of the color original document is divided into color information of R, G and B and are read. Besides, there is also a method in which a light source having spectral characteristics of white is used, color filters of R, G and B are disposed in a light path between this light source and the line sensor, and this color filters are changed so that color information incident on the line sensor is separated.

On the other hand, the three-line CCD line sensor is basically used for color original document reading. In this case, as a light source, one having spectral characteristics to sufficiently cover a visible light region of from 400 nm to 700 nm of oscillation wavelength is used, and the separation of color information of R, G and B is performed by the color filters disposed on the surfaces of the respective line sensors.

Besides, in the case where a monochrome original document is read by using the three-line CCD line sensor, there is a system in which in the three-line CCD line sensor, one output, that is, in general, the output of the CCD line sensor of G is used for the purpose of certainly reading a red seal, and a system in which all outputs of the three-line CCD line sensor are used to generate white and black information.

However, in the related art methods of reading the color original document into the monochrome state, there is a fear that disadvantages as described below occur. For example, in the case where the color original document is read by a general monochrome scanner using a line sensor in which a color filter is not disposed on the light receiving surface, since reflected light from the original document is incident on the line sensor, the change of brightness can be read, however, information relating to the color can not be read. Thus, in the case where information is constructed by a red letter on the original document with a blue background, although the spectral characteristics of the light source have an influence, in the case where the reflectivities are the same, the blue and the red can not be differentiated from each other, and they are processed as the same signal, and when the color original document is read by the monochrome scanner, lack of information occurs, and there is a problem that in the case where the signal is used to perform a copying operation of printing on the paper, the letter, image or the like is lost.

Besides, in the case where a color original document is monochromatically copied by using the three-line CCD sensor in which the color filters of red, blue and green are respectively disposed on the surfaces of the three CCD line sensors, according to the color of the color original document, for example, the color of a letter and the color of the background become the same color, and there is a case where information on the color original document is lost. In the case of the scanner, since the reflected light from the original document is imaged on the respective line sensors and the image information is read, the color information is reproduced by red, blue and green of the three primary colors of light.

Besides, there is a system in which an achromatic color is falsely created by adding wavelength regions of red, blue and green as the color filters on the line sensors. In this case, calculation can be made by using the relation of monochrome information=(red information+blue information+green information)/3.

However, when this processing is used, for example, in the case where information is constructed of a red letter on a blue underground, in the case where the outputs of the respective line sensors at the time of reading the blue information of the underground are (red:blue:green)=(0:255:0), and the outputs of the respective line sensors at the time of reading the red letter information are (red:blue:green)=(255:0:0),

in the case where the blue underground information is converted into monochrome, (0+255+0)/3=85, and
in the case where the red character information is converted into monochrome, (255+0+0)/3=85.

Thus, in the case where the color original document as stated above is monochromatically copied, it is understood that the same density is obtained. Accordingly, in the case where a color original document and a monochrome original document are mixed and inputted into an automatic document feeder, the visibility of the color original document is deteriorated.

Techniques similar to these are disclosed in official gazette (A) JP-A-2003-274115 and official gazette (B) JP-A-11-187266. In the official gazette (A), although a reading apparatus using a four-line line sensor is described, correction of a monochrome signal using a color signal is not performed. In the official gazette (B), although a background removal method is disclosed, the structure is such that a density correction is performed for RGB signals, and is difference from the technique of the invention.

### SUMMARY OF THE INVENTION

The invention has been made to solve the foregoing problems, and has an object to provide an image processing apparatus and an image processing method in which with respect to images read by an image reading apparatus, determination of a color original document or a monochrome original document is made for every some original documents (for example, every document), and a processing suitable for each is used, so that an image with good visibility can be obtained.

In order to solve the problems, an image processing apparatus according to an aspect of the invention includes a first monochrome processing unit configured to perform a monochrome image formation processing on a color original document, a second monochrome processing unit configured to perform a monochrome image formation processing different from the monochrome image formation processing of the first monochrome processing unit on a monochrome original document, and a selection unit configured to selectively use the first monochrome processing unit and the second monochrome processing unit for each original document.

Besides, an image processing apparatus according to another aspect of the invention includes first monochrome processing means for performing a monochrome image formation processing on a color original document, second monochrome processing means for performing a monochrome image formation processing different from the monochrome image formation processing of the first monochrome processing means on a monochrome original document, and selection means for selectively using the first monochrome processing means and the second monochrome processing means for each original document.

Besides, an image processing method performed in a computer of an image forming apparatus according to another aspect of the invention includes the steps of performing a first monochrome image formation processing on a color original document, performing a second monochrome image formation processing different from the monochrome image formation processing performed at the step of performing the first monochrome processing on a monochrome original document, and selectively using the step of performing the first monochrome processing and the step of performing the second monochrome processing for each original document.

### DESCRIPTION OF THE DRAWINGS

FIG. 1 is a side view showing a rough structure of an image reading apparatus of an embodiment of the invention.

FIG. 2 is a view for explaining a structure of a line sensor of the image reading apparatus of FIG. 1

FIG. 3 is a time chart for explaining driving of the line sensor shown in FIG. 2.

FIG. 4 is a graph showing relative sensitivities of the line sensors R, G and B shown in FIG. 2 with respect to incident light wavelength.

FIG. 5 is a time chart for explaining timings of output signals from the line sensors R, G and B of FIG. 2.

FIG. 6 is a graph showing spectral distribution characteristics of a xenon light source.

FIG. 7(a) is a block diagram showing an analog processing circuit to process an output signal of a CCD line sensor, and FIG. 7(b) is a time chart for explaining the processing by the circuit of FIG. 7(a).

FIG. 8 is a block diagram showing the details of a CCD sensor board and a control board shown in FIG. 1.

FIG. 9 is a structural view showing a digital copier of the embodiment of the invention.

FIG. 10 is a block diagram showing the whole system of the copier shown in FIG. 9.

FIG. 11 is a block diagram for explaining a state where the copier singly operates.

FIG. 12 is a block diagram for explaining a state in which as a network scanner, image information read by a scanner unit is outputted to a computer by network connection through a system control unit.

FIG. 13 is a block diagram showing a structure of an image processing unit shown in FIG. 9.

FIG. 14 is a block diagram showing a structure of a color original document monochrome processing unit shown in FIG. 13.

FIG. 15 is a block diagram showing a structure of a hue determination processing unit shown in FIG. 14.

FIG. 16 is a view showing a hue disk used for determination of the hue.

FIG. 17(a) is a view showing a color original image to be read for an image processing, FIG. 17(b) is a view showing a result of printing performed by a related art image processing, FIG. 17(c) is a view showing a result of printing performed by an image processing according to the embodiment of the invention.

FIG. 18 is a block diagram showing a rough structure of a four-line CCD sensor in embodiment 2 of the invention.

FIG. 19 is a block diagram showing a structure of an image processing unit in the embodiment 2 of the invention.

### DESCRIPTION OF THE EMBODIMENTS

Hereinafter, embodiments of the invention will be described with reference to the drawings.

### Embodiment 1

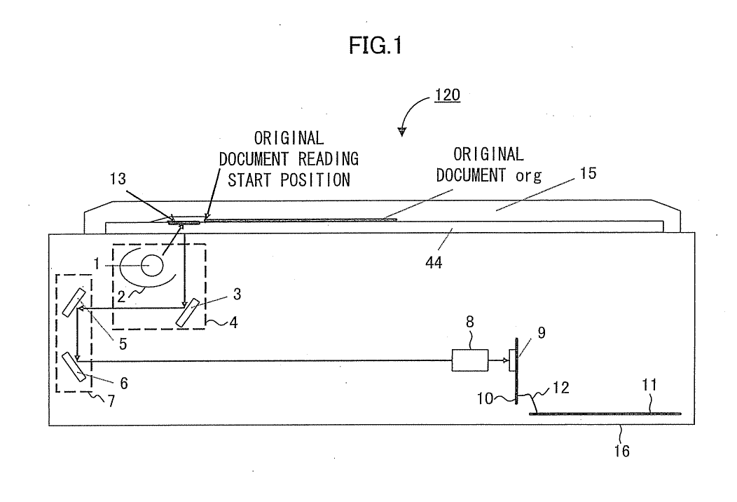

FIG. 1 shows a structure of an image reading apparatus of embodiment 1 of the invention. In this image reading apparatus (after-mentioned image reading unit) 120, an original document org is placed with the bottom up on an original document stand glass 44. When an original document fixing cover 15, which is provided to be openable and closable, is closed, the original document org is pressed onto the original document stand glass 44. The original document org is irradiated by a light source 1, and the reflected light from the original document org is imaged on a sensor surface of a CCD line sensor 9 mounted on a CCD sensor board 10 through a first mirror 3, a second mirror 5, a third mirror 6 and a condensing lens 8. With respect to the original document org, a first carriage 4 including the light source 1 and the first mirror 3, and a second carriage 7 including the second mirror 5 and the third mirror 6 are moved by a not-shown carriage driving motor, and the irradiation light from the light source 1 is scanned on the original document org. In this case, with respect to the movement of the first and the second carriages, since the movement speed of the first carriage 4 is set to be twice as fast as the moving speed of the second carriage 7, a control is performed so that a light path length from the original document org to the CCD line sensor 9 becomes constant.

In this way, the original document org placed on the original document stand glass 44 is sequentially read line after line, and is converted by the CCD line sensor 9 into an analog electric signal corresponding to the intensity of a light signal as the reflected light. Thereafter, the converted analog electric signal is converted into a digital signal, and is delivered to a control board 11 to handle a control signal relevant to the CCD sensor through a harness 12. In the control board 11, a digital signal processing such as a shading (distortion) correction to correct a low frequency distortion due to the condensing lens 8 and a high frequency distortion generated by a variation in sensitivity of the CCD line sensor 9 is performed. Besides, the processing to convert the analog electric signal into the digital signal may be performed by the CCD sensor board 10 or the control board 11 connected through the harness 12.

When the shading correction is performed, a signal as reference of black and a signal as reference of white are required, the former black reference signal is an output signal of the CCD line sensor 9 in a state where the light source 1 is turned off and light is not irradiated to the CCD line sensor 9, and the latter white reference signal is an output signal of the CCD line sensor 9 in a state where the light source 1 is turned on and at the time when a white reference board 13 is read. When this reference signal is generated, in order to reduce the influence due to a singular point or a quantization error, it is generally performed to average signals of plural lines.

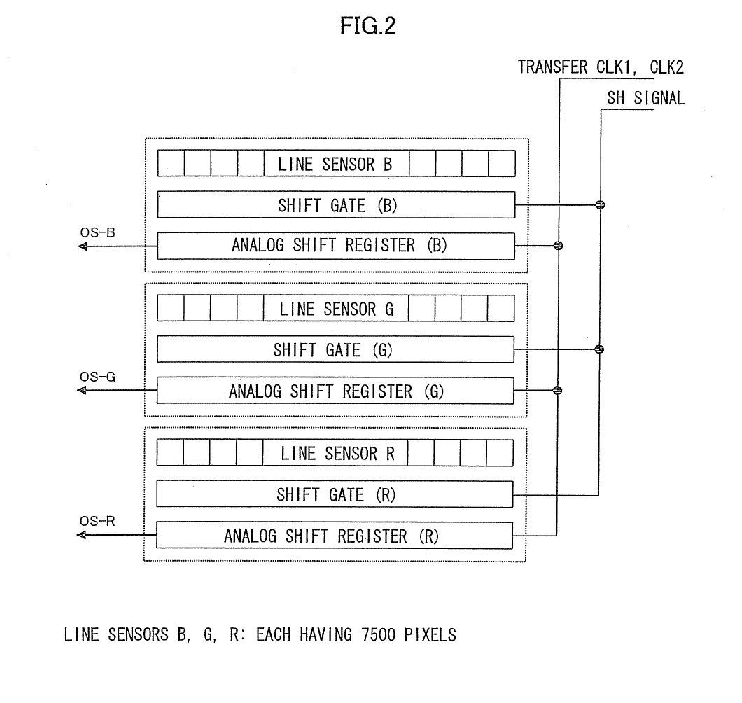

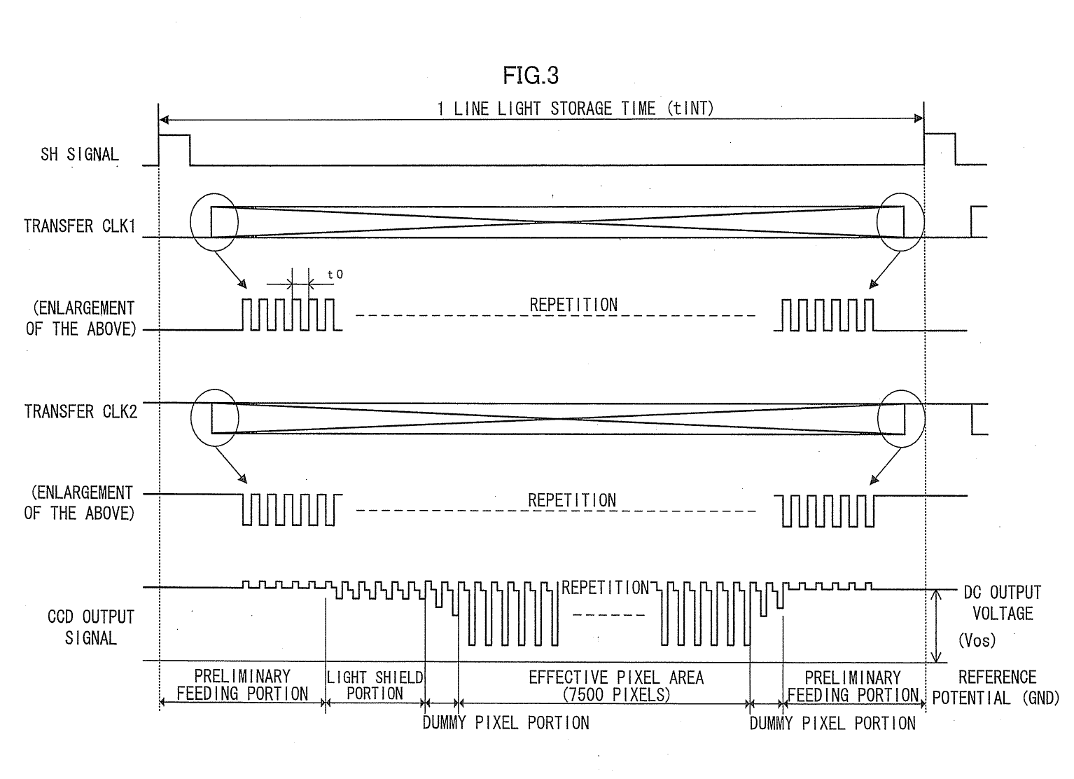

Next, the structure and operation of the CCD line sensor shown in FIG. 1 will be described with reference to FIG. 2 and FIG. 3. FIG. 2 is a rough structural view of a three-line CCD sensor, as one example of the embodiment, including three line sensors in which color filters of blue, green and red (hereinafter respectively denoted as B, G and R) are respectively disposed on light receiving surfaces, that is, a line sensor B, a line sensor G and a line sensor R. The line sensors B, G and R include photodiode arrays, and a photoelectric conversion operation is performed.

The original document org, for example, the original document of A4 size has an area of 297 mm in the long side direction by 210 mm in the short side direction. In the case where the original document reading operation is performed while the long side direction is made the main scanning direction and the short side direction is made the sub-scanning direction, it becomes necessary that the number of effective pixels of the photodiode array of the CCD line sensor 9 is at least 7016 pixels. In general, the sensor has 7500 pixels. Besides, as shown in FIG. 3, the CCD line sensor includes a light shield pixel portion shielded with aluminum at a part of the photodiode array so as to prevent light from being incident on a former stage of the effective pixels of 7500 pixels, dummy pixel portions before and after the effective pixels, and preliminary feeding portions, in order to output all electric charges stored in the CCD line sensor to the outside, the number of transfer CLKs exceeding 7500 pixels is required. Here, when it is assumed that the total of the light shield pixel portion outside the effective pixel area, the preliminary feeding portions, and the dummy pixel portions is 500 in the number of transfer CLKs, in order to output all electric charges stored in the CCD line sensor for one line to the outside of the CCD line sensor, a time equivalent to 8000 transfer CLKs is required, and the time becomes a light storage time (tINT) for one line.

As a feature of an output signal of the CCD line sensor, the signal is outputted based on a voltage level with a constant offset with respect to an electric reference level (GND). The voltage level as the reference is called a signal output DC voltage (offset level: Vos). The light energy irradiated to the line sensor at the time when an SH signal in one line light storage time (tINT) shown in FIG. 3 is at the “L” level is stored as the electric charge in the photodiode, and at the time when the SH signal is at the “H” level, the stored electric charge passes through a shift gate adjacent to the photodiode and is transferred to a further adjacent analog shift register. When this transfer operation is ended, the SH signal is brought to the “L” level to operate the shift gate, so that the electric charge is prevented from leaking out of the photodiode, and the electric charge storage operation is again started by the photodiode.

The electric charge transferred to the analog shift register is transferred to the outside in pixel units and in the period of the transfer CLK. For this operation, the transfer CLK is applied so as to be stopped in the period in which the electric charge is moved from the photodiode through the shift gate to the analog shift register by the SH signal (see FIG. 3). Besides, also in the case where the transfer CLK is always inputted and the transfer CLK is stopped in synchronization with the SH signal in the inside of the CCD line sensor, the charge transfer operation in the inside becomes the same. Besides, although there is a case where the polarities of the SH signal and the transfer CLK are different from FIG. 3 according to the CCD line sensor, the inner operation of the sensor is the same.

The time equivalent to the 8000 transfer CLKs is described as the time, not the number of CLKs, irrespective of the transfer CLK stop state at the time of the SH signal. For example, when it is assumed that the image transfer frequency of the four-line CCD sensor is f=20 MHz, in order to output all charges stored in the line CCD sensor for one line to the outside, a time of

8000 (CLKs)×(1/20 MHz)=400 μs

is required, and this time becomes the light storage time of the line sensor for one line in the sub-scanning direction.

Hereinafter, although the relation of the analog signal amplitude outputted from the line CCD sensor 9 will be described on the condition that the frequency of the transfer CLK (period t0) is 20 MHz and the one line light storage time tINT is 400 μs, the transfer CLK frequency and the one line light storage time naturally vary according to the specifications of the product.

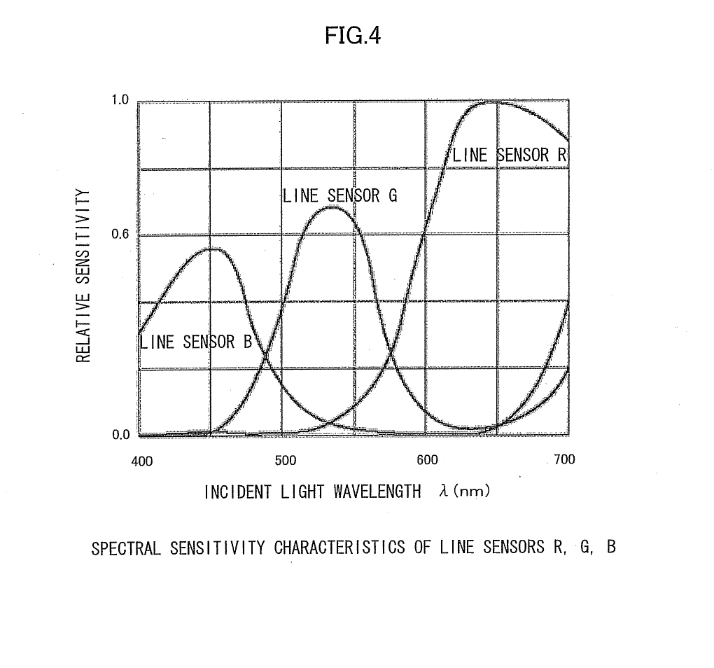

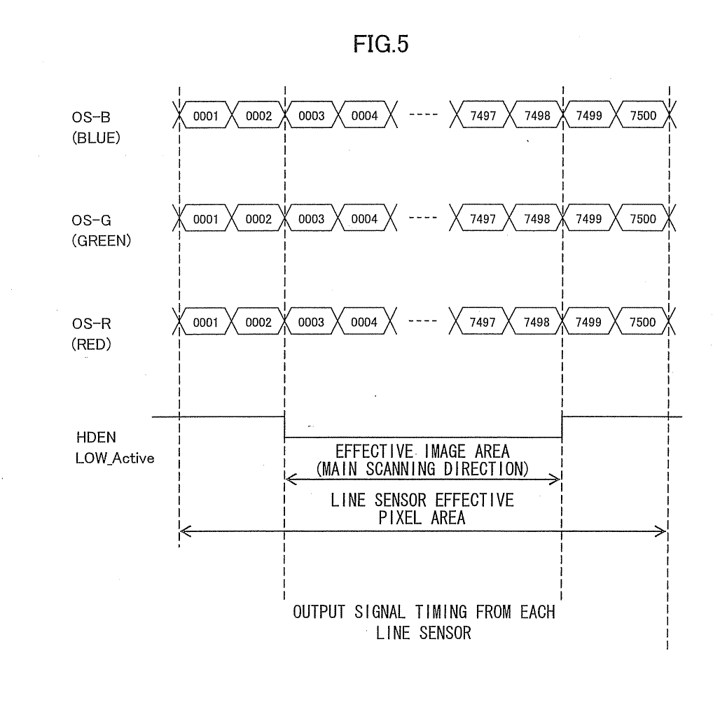

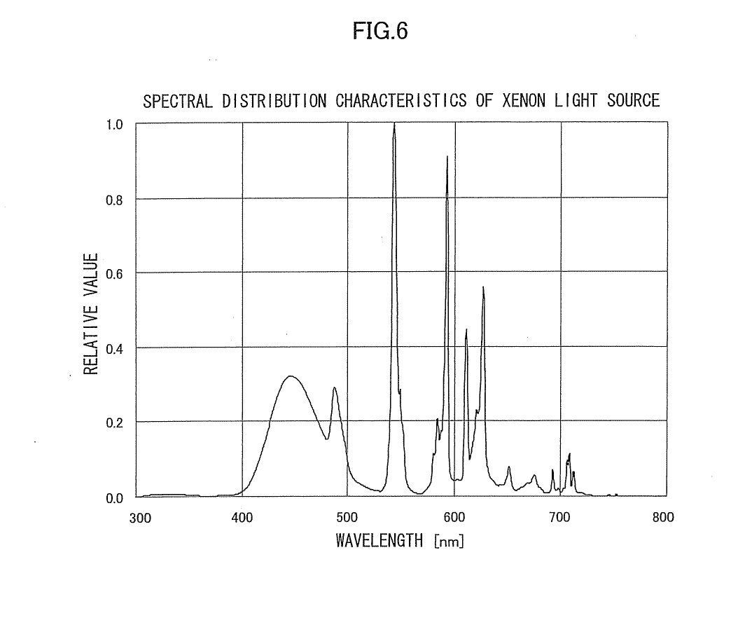

FIG. 4 shows spectral sensitivity characteristics of the CCD line sensors R, G and B. The CCD line sensor 9 includes the line sensors R, G and B in which the color filters are disposed, and in the case where light from the light source is uniformly irradiated to these line sensors, the line sensor R, the line sensor G or the line sensor B has the sensitivity for only the wavelength of a specific region. As shown in FIG. 5, the signals outputted from the CCD line sensor 9 are outputted while the signals B, G and R are synchronized with each other. Besides, the area of all effective pixels of the CCD line sensor 9 is not used as an image, but the pixel number suitable for the read image in the area is selected as the effective image area (period of the “L” level of HDEN signal). For reference, an example of a spectral distribution of a xenon light source is shown in FIG. 6.

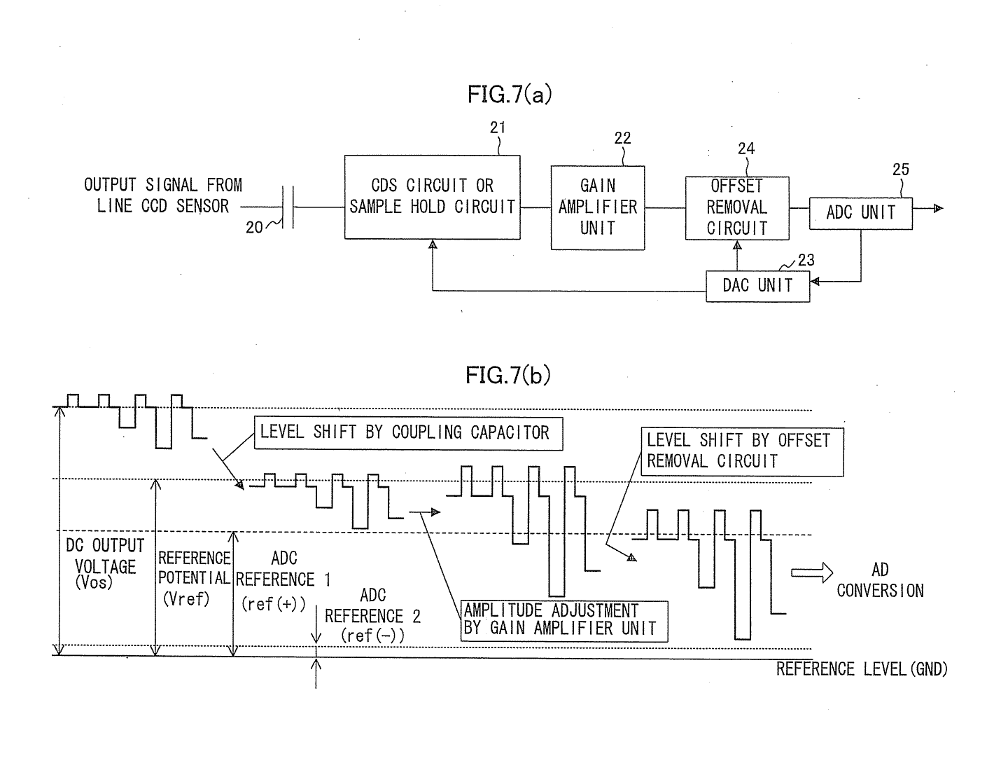

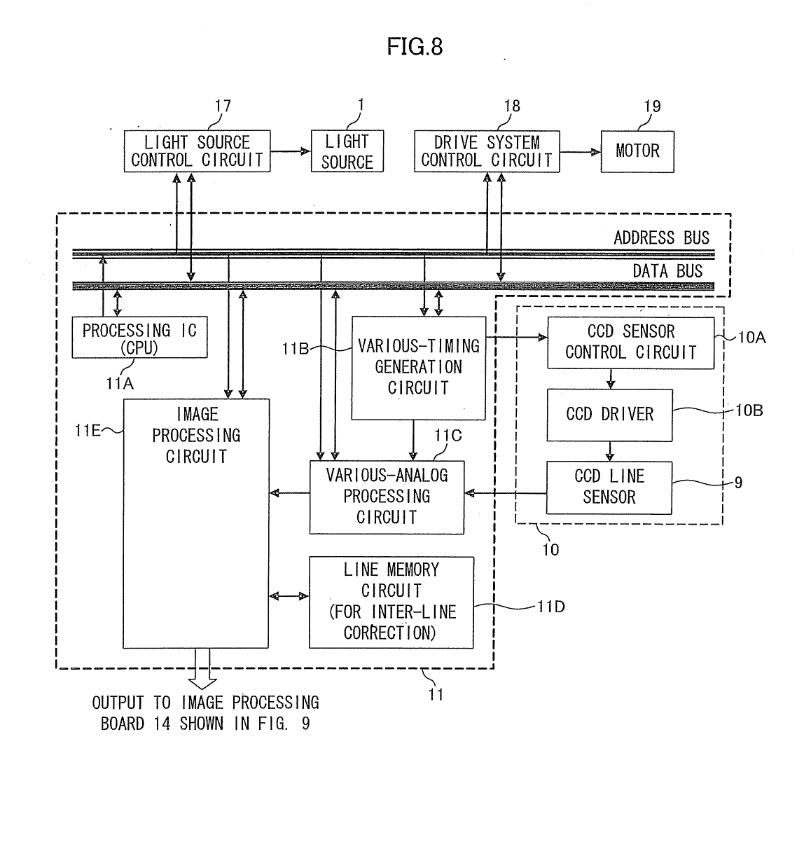

FIG. 7(a) is a block diagram showing a rough structure of an analog processing circuit of an analog signal outputted from the CCD line sensor 9, and FIG. 7(b) is a time chart for explaining an analog waveform in the processing circuit shown in FIG. 7(a). A various-analog processing circuit 11C (see FIG. 8) for the analog signal outputted from the CCD line sensor 9 generally includes a coupling capacitor 20, a CDS (Correlated Double Sampling) circuit as a correlated double sampling circuit or a sample hold circuit 21, a gain amplifier unit 22, a DAC (Digital Analog Converter) unit 23 to convert a digital signal into an analog signal, an offset removal circuit 24 to remove a DC component, and an ADC (Analog Digital Converter) unit 25 to convert an analog signal into a digital signal.

Next, the specific operation of the circuit of FIG. 7(a) will be described with reference to FIG. 7(b). As shown in FIG. 3 as well, the output signal from the CCD line sensor 9 is outputted based on the signal output DC voltage (Vos). This signal output DC voltage (Vos) varies according to the CCD line sensor 9, and in the case of the CCD line sensor using a +12 V power source, it has a variation of about 3 to 8 V. For the purpose of removing the DC component of the signal having this indefinite level, the coupling capacitor 20 is connected in series. At this time, for the processing of the CDS circuit or the sampling circuit 21, a processing is performed so that the potential of the dummy pixel portion or the light shield portion shown in FIG. 3 is made to coincide with the reference potential (Vref).

Next, a processing is performed so that the analog signal from the CCD line sensor in which the DC component is removed is made to coincide with the input range of the later stage ADC unit 25. At that time, in order to make the DC component coincide with the input range, the DC voltage is generated by the DAC unit 23, and in order to make the voltage of the light shield unit of the CCD sensor coincident with the DC voltage, the adjustment of the DC component is again performed by the CDS (Correlated Double Sampling) circuit as the correlated double sampling circuit or the sample hold circuit 21 and the offset removal circuit 24.

As shown in FIG. 7(b), the reference voltage at the “H” level side necessary for the conversion of the ADC 25 is made ADC reference 1 (ref(+)), the reference voltage at the “L” level side is made ADC reference 2 (−), and the processing is performed to enter this voltage range. At this time, when a signal higher than the ADC reference 1 (ref(+)) or lower than the ADC reference 2 (ref(−)) is inputted, the output of the ADC 25 is saturated, and therefore, the signal is absolutely made not to exceed these references.

FIG. 8 shows a rough structure of the control board 11 and the CCD sensor board 10 shown in FIG. 1. The control board 11 includes a processing IC (CPU) 11A such as a CPU, a various-timing generation circuit 11B, the various-analog processing circuit 11C shown in FIG. 7(a), a line memory circuit 11D, and an image processing circuit 11E. The processing IC 11A controls the signal processing system of the CCD line sensor 9, and further, uses control signals of an address bus, a data bus and the like, and controls also a light source control circuit 17 to perform control of the light source 1 and a drive system control circuit 18 to control a motor 19 for moving the first carriage 4 and the second carriage 7.

The various-timing generation circuit 11B generates signals necessary for driving the CCD line sensor 9, such as the SH signal and the transfer CLK1, CLK2 shown in FIG. 3, and signals necessary for various analog processings shown in FIG. 7(a). With respect to the signals generated in the various-timing generation circuit 11B and necessary for the driving of the CCD line sensor 9, the timing adjustment is performed in a CCD sensor control circuit 10A, and the signals are inputted to the CCD line sensor 9 through a CCD driver 10B for signal amplitude level matching or waveform shaping. Here, there is no problem even if the CCD sensor control circuit 10A is included in the various-timing generation circuit 11B. The output from the CCD line sensor 9 is inputted to the various-analog processing circuit 11C, and various analog processings are performed by the circuit shown in FIG. 7(a). Although the various-analog processing circuit 11C is described as the component of the control board 11 in FIG. 8, even if it is disposed on the CCD sensor board 10, there is no problem in function.

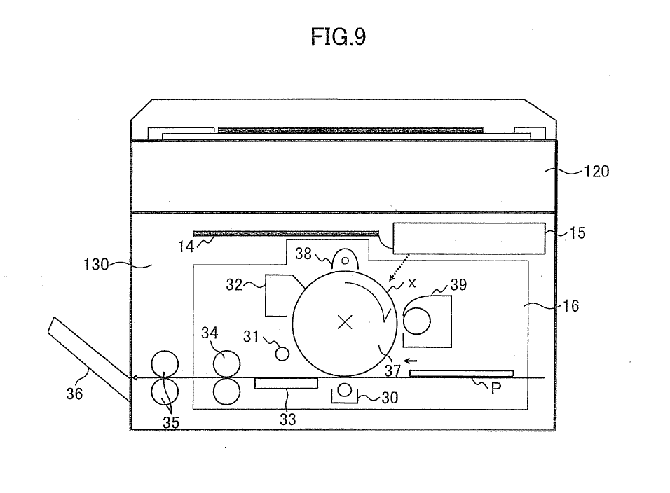

As shown in FIG. 2, in the CCD line sensor 9, since the respective line sensors are arranged to be physically separate from each other, a shift occurs in the reading position of each of the line sensors. The shift in the reading positions is corrected by the line memory circuit 11D. In the image processing circuit 11E, in addition to the control of the line memory circuit 11D, processings, such as shading correction performed using the image signal converted into the digital signal and LOG conversion, are performed. The RGB signals in which various processings have been performed are outputted to an image processing unit 14 incorporated in an image processing board shown in FIG. 9.

FIG. 9 is a schematic view of a digital copier including an image reading apparatus (scanner unit) and a printer unit to form an image on a paper. A printer unit 130 shown in FIG. 9 is shown as an example of a structure to create a monochrome image from an original document read by the scanner unit 120. The printer unit 130 includes the image processing unit 14 to perform processings necessary for creating an image, such as, for example, a filter processing and a gradation processing, to image data read by the CCD line sensor 9 of the scanner unit 120 and to convert it into a control signal of a not-shown light emitting element such as a semiconductor laser, a laser optical system unit 15 in which the light emitting element, such as the semiconductor laser, to form a latent image on a photoconductive drum 37 is arranged, and an image formation unit 16. Besides, the image formation unit 16 includes the photoconductive drum 37 necessary for creating an image by an electrophotographic process, a charging unit 38, a developing unit 39, a transfer charger 30, a peeling charger 31, a cleaner 32, a sheet transport mechanism 33 to transport a sheet P, and a fixing unit 34. The sheet P on which the image has been formed by the image formation unit 16 is discharged onto a paper discharge tray 36 through a discharge roller 35.

Besides, determination of a color original document or a monochrome original document in this embodiment, and a monochrome conversion processing to the color original document are also performed in the image processing unit 14. The details will be described later.

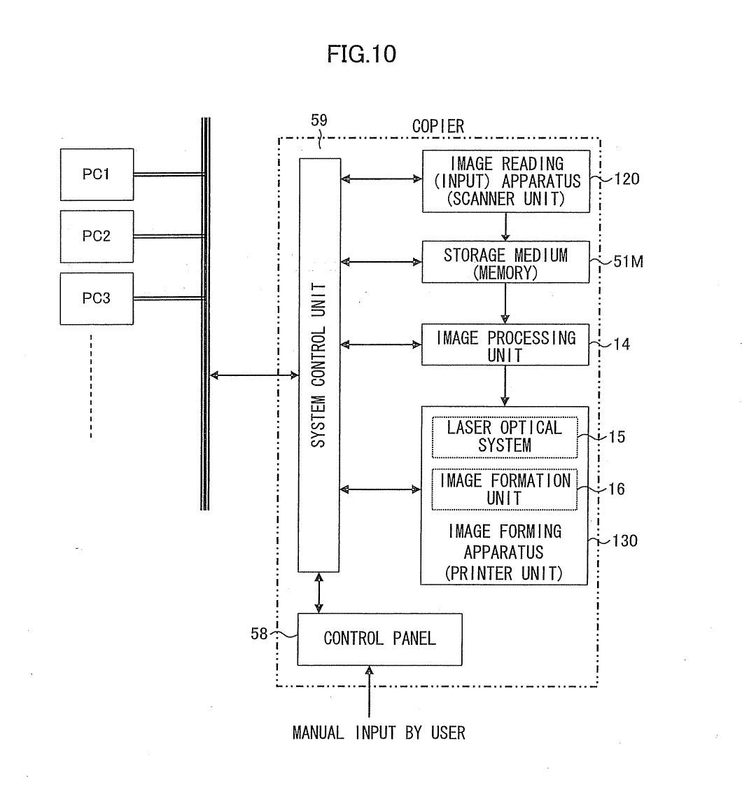

FIG. 10 is a block diagram schematically showing the whole system structure of an image processing apparatus including the image reading apparatus and the image formation apparatus as shown in FIG. 9. This system includes the scanner unit (image reading apparatus) 120, a memory 51M as a recording medium, the image processing unit 14 to perform various image processings, the laser optical system 15 using a semiconductor laser, and the image formation unit 16 using an electrophotographic process to form an image with toner, and further includes a system control unit 59 to perform control of them, and a control panel 58 by which the user directly makes an input. The laser optical system 15 and the image formation unit 16 constitute an image formation apparatus (printer unit) 130.

Here, the image processing unit 14 corresponds to the image processing apparatus of the invention. Incidentally, in this embodiment, although the image processing unit 14 is provided separately from the image reading apparatus (scanner unit) 120, it is needless to say that an image reading apparatus in which these are integrated can be provided, or an image forming apparatus in which the image processing unit 14 is integrated with the image forming apparatus 130 can be provided.

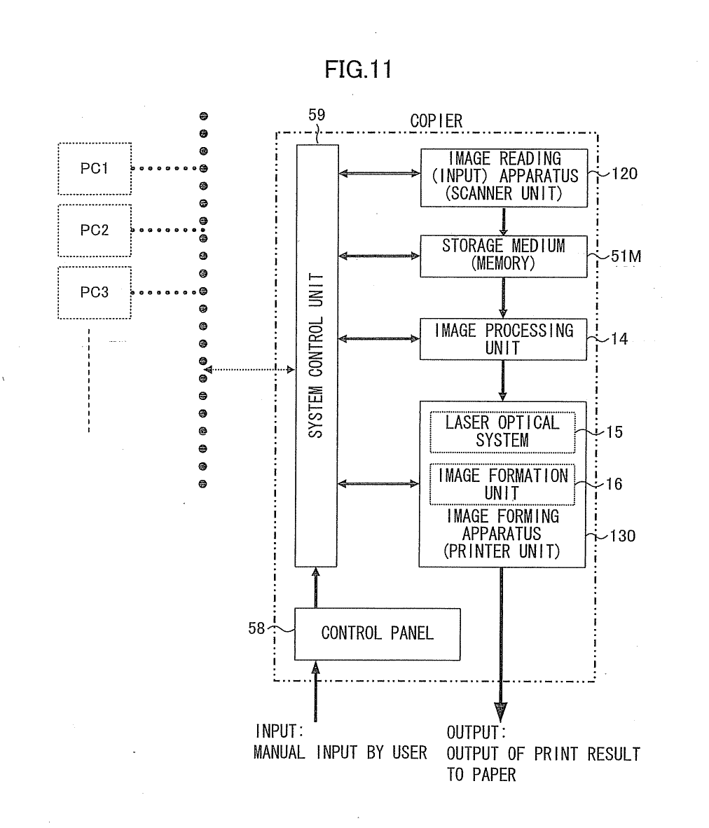

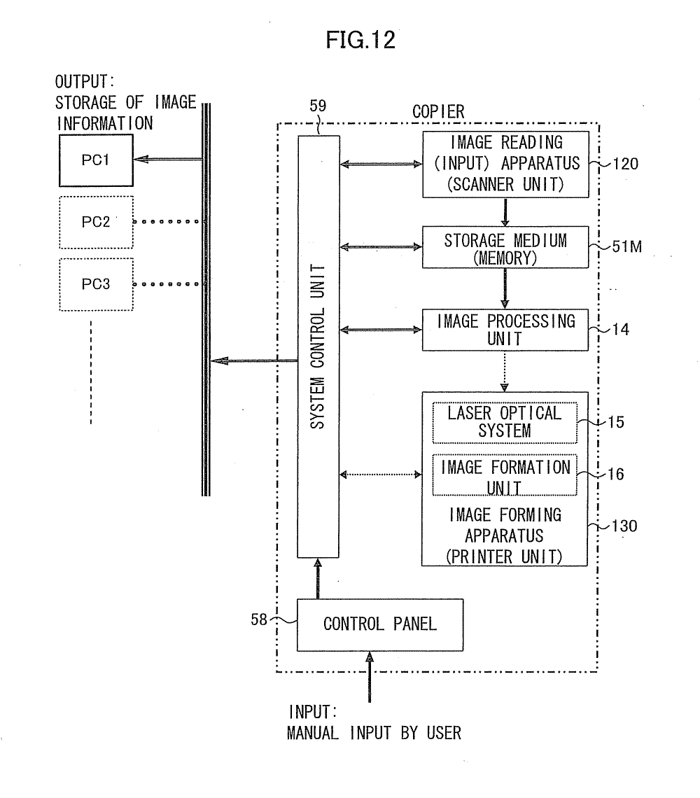

FIG. 11 is an explanatory view of a case where the system of FIG. 10 is used as a copier, and FIG. 12 is an explanatory view of a case where the system of FIG. 10 is connected to a network and is used as a scanner from external computers PC1, PC2, PC3, . . . .

In FIG. 11, although the apparatus is connected to the network through the system control unit 59, the operation is performed by the copying apparatus alone. First, the user sets the original document org to be copied on the scanner unit 120 as the image reading apparatus, and makes a desired setting from the control panel 58. The control panel 58 includes a copy/scanner button to set whether the image processing apparatus is used as the copier to perform a copying work or is used as the scanner which is the image reading apparatus, an original document mode designation button to designate an original document mode, a display unit to display an enlargement/reduction processing and the set number of sheets, a key button to input the desired number of sheets, a copy number setting unit including a clear button to clear the inputted numerical value, a reset button to initialize a condition set by the control panel, a stop button to stop a copy operation or a scanner operation halfway, and a start button to start the copy operation or the scanner operation. Besides, various setting buttons on the control panel may be constructed of, for example, a touch panel using a liquid crystal and may be used together with the display unit.

Incidentally, the designation of a color and monochrome mixture mode (color original document mixture mode) in the embodiment of the invention is also set by this control panel. Here, the control panel constitutes a color original document mixture mode setting unit (setting means) of the invention. The color and monochrome mixture mode will be described later.

When the original document org is set, the original document press cover 15 is closed, the control panel 58 is used to set the kind of the original document, the sheet size outputted with respect to the original document size, the number of sheets copied for one original document, and the like, and the start button is depressed, so that the copy operation is started. At this time, image information read by the scanner unit 120 is temporarily stored in the memory 51M as the storage medium (apparatus). This memory is constructed of a page memory having a capacity larger than a capacity capable of storing all image information of the maximum copiable size. An image signal outputted from this memory is subjected to processings, such as a filter processing and a gradation processing, by the image processing unit 14, is converted into a control signal of the semiconductor laser, and is inputted to the later stage laser optical system 15. The image signal is converted into an optical output of the semiconductor laser by the laser optical system 15, and it is irradiated to the photoconductor 37 of the image formation unit 16. The image formation unit 16 forms an image by an electrophotographic process.

By use of FIG. 12, a description will be given to an example of an operation as a network scanner in which with respect to image information read by the scanner unit 120, an image is outputted to the network-connected computer through the system control unit 59. The user sets the original document org on the scanner unit 120, and uses the control panel 58 to set the kind of the original document org, the size, and the copy operation or the scanner operation. Besides, the address of the network-connected computer PC1 as the destination of the image information is set, and the start button is depressed so that the operation is started. The image information read by the scanner unit 120 is stored in the memory 51M, and thereafter, together with the processing in this embodiment, a desired compression processing, such as JPEG or PDF form, is performed as the need arises in the later stage image processing unit 14. The compressed image information is transferred to the external computer PC1 through the system control unit 59 and through the network.

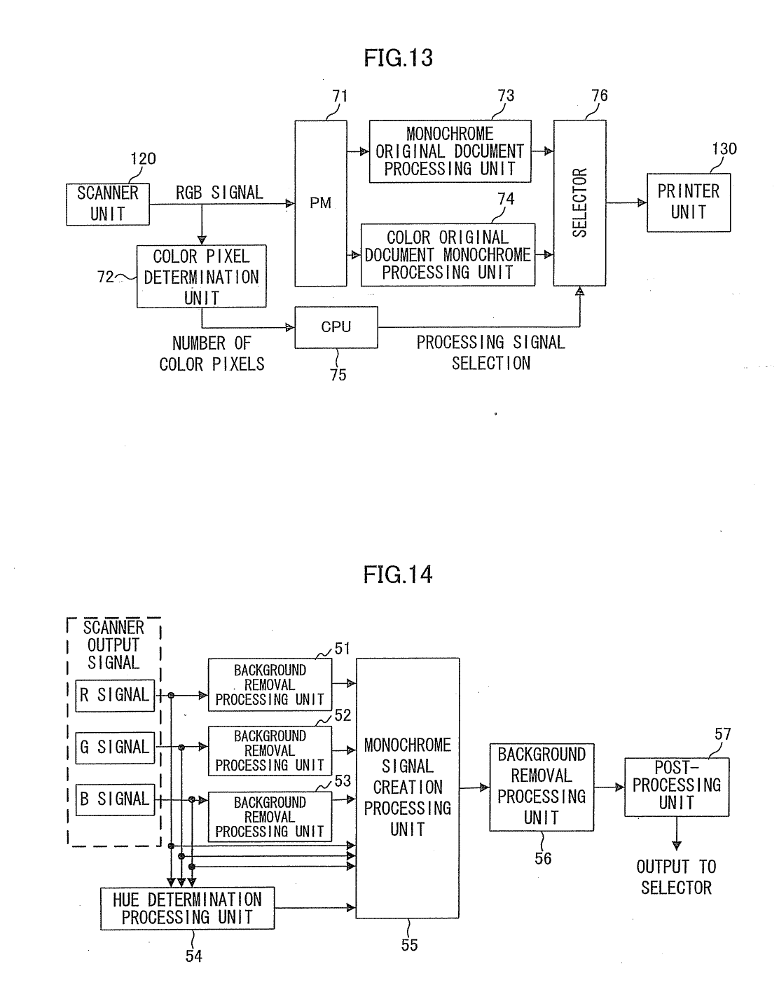

The structure of the image processing unit in the embodiment of the invention will be described by use of FIG. 13. The color signals (RGB signals) outputted from the scanner unit 120 are stored in a page memory (hereinafter abbreviated to PM) 71 and are simultaneously inputted to a color pixel determination unit 72. An image (RGB image) based on the RGB signals inputted to the PM 71 is inputted to a monochrome original document processing unit (second monochrome processing unit or second monochrome processing means) 73 and a color original document monochrome processing unit (first monochrome processing unit or first monochrome processing means) 74, and the respective processing results are selected by a selector 76 and are outputted to a printer unit 130. A CPU 75 outputs a switching signal to the selector 76 based on the output signal from the color pixel determination unit 72. Here, the CPU 75 constitutes a selection unit (selection means) of the invention.

In the case where the color monochrome mixture mode is selected by the control panel, the color pixel determination unit 72 uses the RGB signals outputted from the scanner unit 120 to determine whether each original document is a color original document or a monochrome original document, and a processing suitable for the color original document or the monochrome original document is performed.

The color pixel determination unit 72 calculates |R−G|, |G−B| and |B−R| for each pixel with respect to the inputted RGB signals. With respect to the calculated |R−G|, |G−B| and |B−R|, average values are calculated in 5×5 area units. With respect to the calculated average values (respectively defined as ave(|R−G|), ave(|G−B|) and ave(|B−R|)), the total number of color pixels is calculated using the following conditional expression.

If (ave(|R−G|)>th1 or ave(|G−B|)>th2 or ave(|B−R|)>th3), then count is made as a color pixel→col_cnt=col_cnt+1 else count is not made.

Where, the initial value of col_cnt is 0, and the initialization is performed for each original document.

The comparison processing as stated above is performed for the whole area of the original document, so that the total number of color pixels existing on the original document is found. The number of color pixels indicated by col_cnt is outputted to the CPU 75, and the CPU 75 compares a previously set threshold value colth with the col_cnt value (specified threshold value), and determines whether the original document is the color original document or the monochrome original document. Here, with respect to the threshold value colth, the structure may be made such that the threshold value can be adjusted from the control panel or the like.

The determination result of the color original document or monochrome original document is outputted as the processing selection signal to the selector 76, and the color original document monochrome processing or the monochrome original document processing is selected.

For example, when the input original document is the monochrome original document, the output of the monochrome original document processing unit 73 is selected. The monochrome original document processing unit 73 performs an RGB averaging processing on the RGB signals inputted from the PM 71, and creates a monochrome signal. The monochrome signal is subjected to a background removal processing, a filter processing, a binary error diffusion processing and the like and is outputted to the selector 76.

On the other hand, in the case where the input original document is the color original document, the color original document monochrome processing unit 74 is selected. In the color original document monochrome processing unit 74, as shown in FIG. 14, the RGB signals from the PM 71 are individually inputted to background removal processing units 51 to 53.

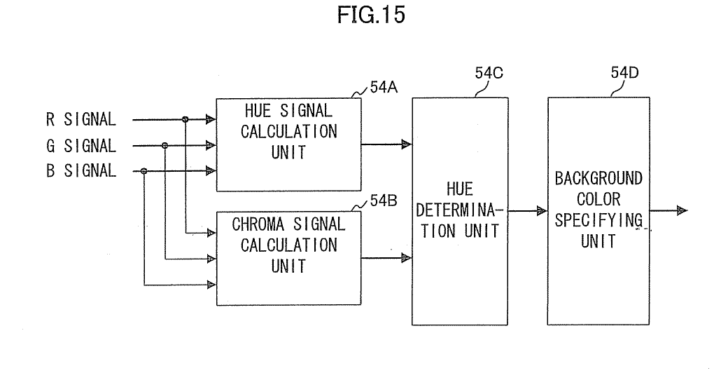

The structure of the color original document monochrome processing unit 74 in this embodiment will be described with reference to FIG. 14 and FIG. 15. The color signals (RGB signals) outputted from the scanner unit 120 are respectively differentiated and are independently (individually) inputted to the background removal processing units 51, 52 and 53. In the background removal processing units 51, 52 and 53, histograms are calculated on the inputted signals for each sub-scanning line, and a signal value at which the maximum frequency is obtained is calculated as the white reference value. A renormalization operation is performed using the calculated white reference value and a previously set black reference value, so that the background removal processing is performed. The renormalization operation expression is as follows:

OUTimg=(INimg−black reference value)/(white reference value−black reference value)×255

Where, OUTimg denotes the output signal of the renormalization, and INimg denotes the input image signal.

A hue determination processing unit 54 uses the RGB signals, and calculates the hue and chroma as shown in FIG. 15. Specifically, from the RGB signals, a hue signal calculation unit 54A and a chroma signal calculation unit 54B use the following arithmetic expressions to calculate a hue signal and a chroma signal.

hue signal=tan⁻¹((R−G)/(G−B)*180)/π

chroma signal=Max(|R−G|, |G−B|)

Where, Max(|R−G|, |G−B|) means that the absolute value of R−G and the absolute value of G−B are compared with each other, and a larger value is outputted.

From the calculated hue and chroma signals, the hue is determined by a hue determination unit 54C. Specifically, the calculated chroma signal is compared with a threshold value the and a density threshold value thd, and the determination of a chromatic color, Black or White is made.

If chroma signal<the and MAX(R,G,B)<thd, then Black.

If chroma signal<the and MAX(R,G,B)≧thd, then White.

If chroma signal≧thc, then chromatic color.

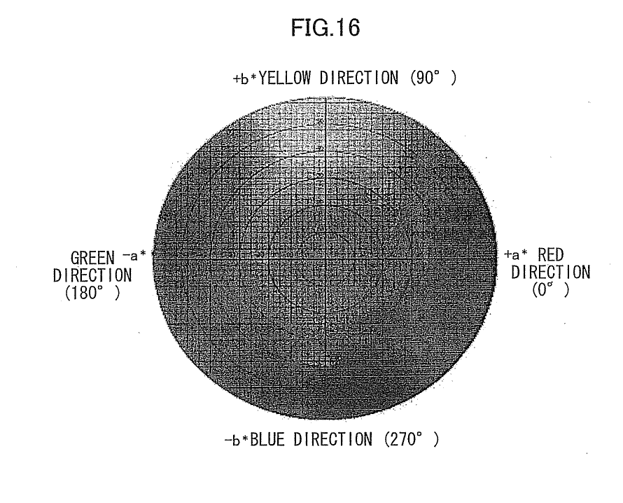

As a result of the determination, in the case where the determination of the chromatic color is made, the hue is determined using the hue signal. Specifically, as indicated by a hue disk of FIG. 16, the hue signal can represent the hue by an angle such that Red is made 0°, Yellow is about 90°, Green is 180°, and Blue is 270°. Thus, the obtained hue signal is compared by the following conditional expression, so that the hue can be determined.

Conditional Expression:

If hue signal≦thh1 or hue signal>thh6, then Red.

If thh1<hue signal≦thh2, then Yellow.

If thh2<hue signal≦thh3, then Green.

If thh3<hue signal≦thh4, then Cyan.

If thh4<hue signal≦thh5, then Blue.

If thh5<hue signal≦thh6, then Magenta.

From the above determination, the hue of each pixel is determined.

The hue result determined by the hue determination unit 54C is inputted to a background color specifying unit 54D. In the background color specifying unit 54D, the total number of frequency of hue of Black/Red/Yellow/Green/Cyan/Blue/Magenta/White in an area of 7016 pixels in main scanning×three lines in sub-scanning (one line before and after the processing line) is calculated. The calculated total number of frequency of each hue is compared with a specified threshold value, so that the color as the background of the processing line is specified (determined). Specifically, the color is specified under the following condition.

Conditional Expression:

If the total number of frequency of Black>bg_th1, then Black hue is background.

If the total number of frequency of Black≦bg_th1, then Black hue is non-background.

If the total number of frequency of Red>bg_th2, the Red hue is background.

If the total number of frequency of Red≦bg_th2, then the Red hue is non-background.

Where, the threshold value determination is similarly made on each of Yellow, Green, Cyan, Blue, Magenta and White.

In a monochrome signal generation processing unit 55 (FIG. 14), a monochrome signal is generated using the RGB signals (respectively defined as rng_R, rng_G and rng_B) outputted from the background removal processing units 51, 52 and 53, the RGB signals outputted from the scanner unit 120, the hue determination results of the respective pixels outputted from the hue determination processing unit 54, and the background color determination results in line units. Specifically, the monochrome signal to be outputted is determined by the following condition.

| | background | monochrome |
|---|---|---|
| result of hue | determination | output |
| of noted pixel | result | signal |
| Black | background | 255 − Max (rng_R, rng_G, |
| | | rng_B) |
| | non-background | 255 − Max (rng_R, rng_G, |
| | | rng_B) |
| Red | background | 255 − rng_R |
| | non-background | 255 − (G + B)/2 |
| Yellow | background | 255 − (rng_R + rng_G)/2 |
| | non-background | 255 − B |
| Green | background | 255 − rng_G |
| | non-background | 255 − (R + B)/2 |
| Cyan | background | 255 − (rng_G + rng_B)/2 |
| | non-background | 255 − R |
| Blue | background | 255 − rng_B |
| | non-background | 255 − (R + B)/2 |
| Magenta | background | 255 − (rng_G + rng_B)/2 |
| | non-background | 255 − G |
| White | background | 255 − Min(R, G, B) |
| | non-background | 255 − Min(R, G, B) |

The reason why a subtraction is made for each monochrome output signal from 255 is that in the RGB signal system, white is represented by “255” and black is represented by “0”, however, as the monochrome signal, white is represented by “0”, and black is represented by “255”, and therefore, the subtraction is made.

The reason why different RGB signals are used for the background and the non-background as described above is that for example, when the case of the Red hue is considered as an example, in the case where a red original document is read, in the ideal state, the RGB signals outputted from the scanner unit are Red=255, Green=0 and Blue=0. Here, in the case of the background, the Red signal is used, so that the value of the background becomes “0” in the case where a conversion is made into monochrome. Besides, in the case of the non-background, that is, in the case of a letter, it is necessary that the letter is outputted as black when the conversion is made into the monochrome, and therefore, Green and Blue signals are used. Since the Green and Blue signals are “0”, in the case where the conversion is made into the monochrome, black becomes “255”. In the actual scanner, since a signal is not outputted in the ideal state as stated above, with respect to the hue determined to be the background, a signal in which the background removal processing has been performed is used, so that fogging (non-background merges with the background) at the time when the conversion is made into the monochrome is suppressed.

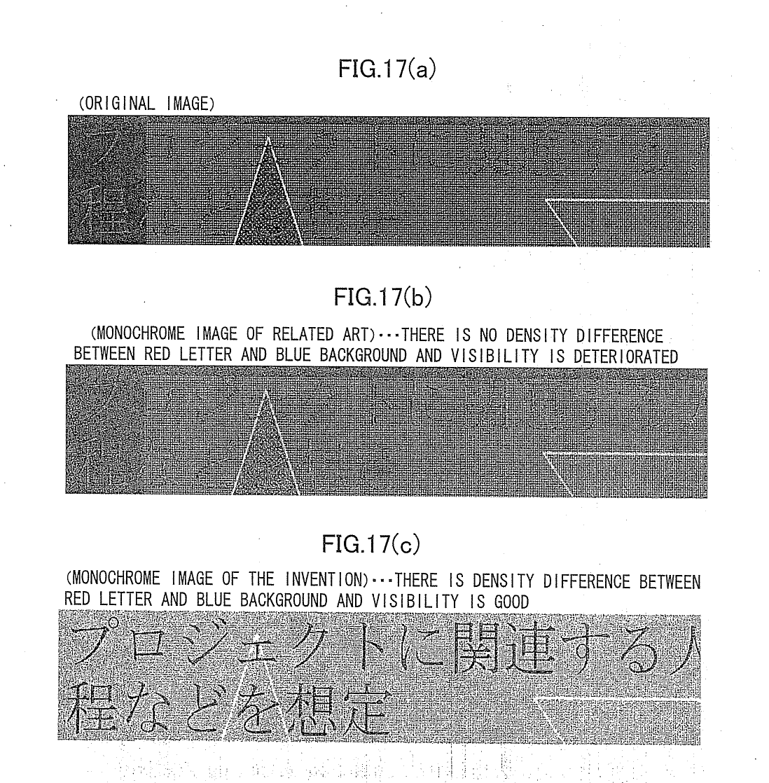

When the background removal processing unit 56 performs the background removal processing on the signal obtained from the conversion into the monochrome as stated above, the further removal of the background can be performed. The processing method in the background removal processing unit 56 is similar to the case of the background removal processing units 51, 52 and 53 described before. A post-processing unit 57 performs a gradation processing such as a filter processing or a binary error diffusion to the signal outputted from the background removal processing unit 56, and delivers the processing result as an engine output to a later stage circuit. By performing the processing as stated above, as shown in FIG. 17, it is possible to realize the image without fogging or crush. That is, according to the image processing apparatus of the related art, a color original image shown in FIG. 17(a) is not clearly printed as shown in FIG. 17(b), however, according to the image processing apparatus of the embodiment, as shown in FIG. 17(c), it is clearly printed.

Next, the operation of the monochrome correction processing at the time of a copy operation and the time of a network scan operation in the embodiment will be described. The basic structure is the same as the copy operation described before. Similarly to the copy operation, the signal generated by the monochrome signal generation processing unit 55 is used, and the background removal processing by the background removal processing unit 56 and the filter processing by the post-processing unit 57 are performed on the RGB signals outputted from the scanner and the image creation is performed. Thereafter, a not-shown resolution conversion processing or compression processing is performed, and image data is outputted to the PC connected to the network. By this, even in the case where use is made as the network scanner, an image without fogging or crush can be realized. As stated above, according to the embodiment, with respect to the image read by the image reading apparatus, the background color is specified, and one of the RGB signals is used to generate the monochrome signal, so that a high quality image output in which image crush does not occur can be provided.

### Embodiment 2

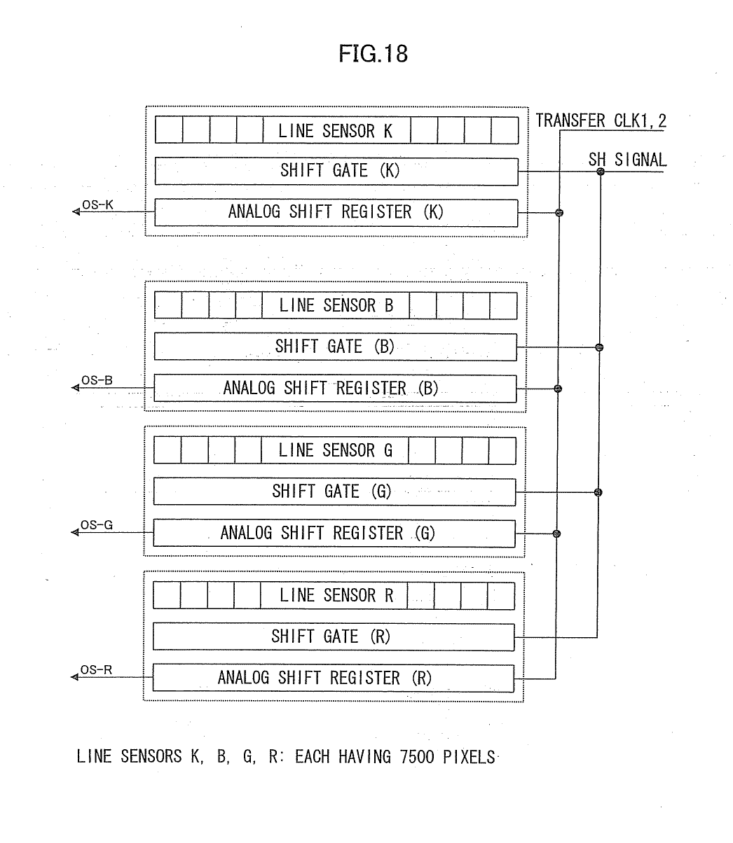

Next, as embodiment 2, a description will be given to a case where a four-line sensor as shown in FIG. 18 is used as a CCD line sensor (image reading unit, image reading means). A scanner unit 120 has the same structure except the line sensor, and a printer unit 130 has also the same structure.

FIG. 18 is a schematic structural view of the four-line CCD sensor including one line sensor K in which a color filter is not disposed on a light receiving surface, and three line sensors (line sensor B, line sensor G, line sensor R) in which color filters of blue, green and red (hereinafter abbreviated to B, G and R) are respectively disposed on light receiving surfaces, that is, the four line sensors in total.

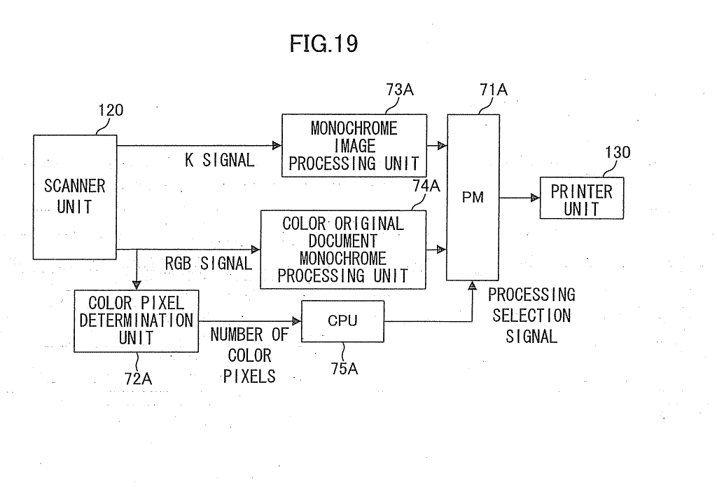

The line sensors K, B, G and R include photodiode arrays, and the photoelectric conversion operation is performed. Signals outputted from the four-line CCD sensor are subjected to an analog processing and the like, and are further subjected to processings such as shading correction and Log conversion, and are inputted to an image processing unit shown in FIG. 19.

FIG. 19 is a block diagram showing a structure of the image processing unit (corresponding to the image processing apparatus) in the embodiment 2. In this image processing unit, a monochrome original document processing unit (second monochrome processing unit) 73A performs a monochrome original document processing using an inputted K signal, and a color original document monochrome processing unit (first monochrome processing unit) 74A performs a color original document processing using RGB signals inputted at the same time. Monochrome binary images in which the respective processings have been performed are simultaneously stored in a PM 71A.

The RGB signals are also inputted to a color pixel determination unit 72A, the number of color pixels is counted for each page, and the number of color pixels is outputted to a CPU 75A. The CPU 75A (selection unit, selection means) compares the number of color pixels with a specified threshold value to make determination of a color original document or a monochrome original document, selects one of the image data for the color original document and the image data for the monochrome original document simultaneously stored in the PM 71A, and outputs it to the printer unit 130. By using the structure as stated above, the data stored in the PM 71A can be made monochrome binary data, and the memory capacity can be reduced as compared with the case where the RGB signals used in embodiment 1 are stored. Besides, it becomes possible to improve the visibility of a color original document and a monochrome original document.

By using the structure as stated above, the image data in the case where the determination of the monochrome original document is made and the monochrome image data in the case where the determination of the color original document is made can be stored temporarily in the PM 71A. Thus, the CPU 75A reads the data stored in the PM 71A and can display the image on the control panel, and the user can confirm the finish before it is outputted to a sheet. After confirming the finish, the user can select the output mode from two outputs, that is, the monochrome output and the color original document monochrome output. In the case where the selection result of the user is not coincident with the determination result of the CPU 75A, for example, the selection result of the user is given priority, and the image output can be performed. By the above structure, it becomes possible for the user to confirm the finish in the case where the color original document is monochromatically outputted, and a miss copy can be prevented.

What is claimed is:

1. An image processing apparatus comprising:
a first monochrome processing unit configured to perform a monochrome image formation processing on a color original document;
a second monochrome processing unit configured to perform a monochrome image formation processing different from the monochrome image formation processing of the first monochrome processing unit on a monochrome original document; and
a selection unit configured to selectively use the first monochrome processing unit and the second monochrome processing unit for each original document.

2. The image processing apparatus according to claim 1, wherein the selection unit determines, with respect to each acquired original document, whether the original document is the color original document or the monochrome original document, and selects at least one of outputs of the first monochrome processing unit and the second monochrome processing unit based on a result of the determination.

3. The image processing apparatus according to claim 2, further comprising a color original document mixture mode setting unit configured to enable a user to set, as a color original document mixture mode, a mode in which a determination operation of the selection unit is performed for each original document.

4. The image processing apparatus according to claim 1, wherein both the first monochrome processing unit and the second monochrome processing unit use RGB signals to perform the image formation processings.

5. The image processing apparatus according to claim 1, further comprising an image reading unit capable of reading RGB signals and a monochrome signal, wherein
the first monochrome processing unit uses the RGB signals to perform the image formation processing, and
the second monochrome processing unit uses the monochrome signal to perform the image formation processing.

6. The image processing apparatus according to claim 3, wherein when the color original document mixture mode by the color original document mixture mode setting unit is set, the selection unit stores images formed by the first monochrome processing unit and the second monochrome processing unit into a storage unit, and displays the images stored in the storage unit by a display unit.

7. The image processing apparatus according to claim 6, wherein the selection unit causes the user to select the images formed by the first monochrome processing unit and the second monochrome processing unit and displayed by the display unit.

8. The image processing apparatus according to claim 6, further comprising an image reading unit capable of reading RGB signals and a monochrome signal, wherein
the first monochrome processing unit uses the RGB signals to perform the image formation processing, and
the second monochrome processing unit uses the monochrome signal to perform the image formation processing.

9. The image processing apparatus according to claim 2, wherein the selection unit uses the RGB signals to obtain the total number of color pixels in the original document, and compares the number of color pixels with a specified threshold value to determine whether the original document is the color original document or not.

10. The image processing apparatus according to claim 1, wherein the first monochrome processing unit includes a background removal processing unit configured to perform a background removal processing on each signal of RGB signals.

11. An image processing apparatus comprising:
first monochrome processing means for performing a monochrome image formation processing on a color original document;
second monochrome processing means for performing a monochrome image formation processing different from the monochrome image formation processing of the first monochrome processing means on a monochrome original document; and
selection means for selectively using the first monochrome processing means and the second monochrome processing means for each original document.

12. The image processing apparatus according to claim 11, wherein the selection means determines, with respect to each acquired original document, whether the original document is the color original document or the monochrome original document, and selects at least one of outputs of the first monochrome processing means and the second monochrome processing means based on a result of the determination.

13. The image processing apparatus according to claim 12, further comprising color original document mixture mode setting means for enabling a user to set, as a color original document mixture mode, a mode in which a determination operation of the selection means is performed for each original document.

14. The image processing apparatus according to claim 11, wherein both the first monochrome processing means and the second monochrome processing means use RGB signals to perform the image formation processings.

15. The image processing apparatus according to claim 11, further comprising image reading means capable of reading RGB signals and a monochrome signal, wherein
the first monochrome processing means uses the RGB signals to perform the image formation processing, and
the second monochrome processing means uses the monochrome signal to perform the image formation processing.

16. The image processing apparatus according to claim 13, wherein when the color original document mixture mode by the color original document mixture mode setting means is set, the selection means stores images formed by the first monochrome processing means and the second monochrome processing means into a storage unit, and displays the images stored in the storage unit by display means.

17. The image processing apparatus according to claim 16, wherein the selection means causes the user to select the images formed by the first monochrome processing means and the second monochrome processing means and displayed by the display means.

18. The image processing apparatus according to claim 16, further comprising image reading means capable of reading RGB signals and a monochrome signal, wherein
the first monochrome processing means uses the RGB signals to perform the image formation processing, and
the second monochrome processing means uses the monochrome signal to perform the image formation processing.

19. An image processing method comprising the steps of:
performing a first monochrome image formation processing on a color original document;
performing a second monochrome image formation processing different from the monochrome image formation processing performed at the step of performing the first monochrome processing on a monochrome original document; and
selectively using the step of performing the first monochrome processing and the step of performing the second monochrome processing for each original document.

20. The image processing method according to claim 19, wherein at the step of selectively using, it is determined whether, with respect to each acquired original document, the original document is the color original document or the monochrome original document, and at least one of outputs of the step of performing the first monochrome processing and the step of performing the second monochrome processing is selected based on a result of the determination.
